(19) United States
(12) Patent Application Publication
(10) Pub. No.: US 2014/0203794 A1
(43) Pub. Date: Jul. 24, 2014

(54) METHODS AND STRUCTURES FOR DYNAMICALLY CALIBRATING REFERENCE VOLTAGE

(71) Applicants: STEFANO PIETRI, Austin, TX (US); Chris C. Dao, Pflugerville, TX (US); Juxiang Ren, Austin, TX (US)

(72) Inventors: STEFANO PIETRI, Austin, TX (US); Chris C. Dao, Pflugerville, TX (US); Juxiang Ren, Austin, TX (US)

(21) Appl. No.: 13/748,798

(22) Filed: Jan. 24, 2013

(51) Int. Cl. G05F 3/02

(52) U.S. Cl. CPC G05F 3/02
USPC 323/313

(57) ABSTRACT

A bandgap reference system has a bandgap circuit, an operational transconductance amplifier, and an offset controller. The bandgap circuit includes a pair of diode devices and has a reference terminal at which is provided a bandgap reference voltage. The bandgap circuit provides a differential output having a first output and a second output. The operational transconductance amplifier has a first input coupled to the first output of the bandgap circuit, a second input coupled to the second output of the bandgap reference circuit, and an output coupled to the reference terminal. The offset controller is coupled to the operational transconductance amplifier and to the first and second outputs of the bandgap circuit. The offset controller trims the operational transconductance amplifier as needed to ensure an offset of the operational transconductance amplifier is below a predetermined level.

### BACKGROUND

1. Field

This disclosure relates generally to semiconductor devices, and more specifically, to dynamically calibrating reference voltage in a band gap circuit.

2. Related Art

Advanced semiconductor devices require a supply voltage with 100 milliVolts (mV) range or less. Considering that several tens of milliVolts are eroded by current-resistance (IR) drop within the device and test equipment limitations for calibrating the band gap circuits to correct variation of low voltage detectors (LVD), the regulator may not have any operational margin. Yet, it is desirable to provide an LVD with small variation over corner voltages and a wide range of temperatures to allow a microprocessor core to run at tighter voltage with advantages of improved speed, reduced power consumption and leakage, and to increase the reliability of operation. In order to achieve precise LVDs, a precise voltage reference is required. Therefore a band gap circuit that generates the reference voltage may be calibrated or trimmed to achieve a small variation, however the trimming code can only be read as the system is starting and several complications arise.

Conventional band gap reference circuits are composed of a delta base-emitter voltage (Vbe) cell, an amplifier, and a start-up section. Error introduced by the amplifier is equal to its input (referred offset voltage (Vos)) multiplied by a band gap loop gain, which is a gain factor that usually ranges between 10 and 20. An input referred offset voltage of 1 milliVolts (mV) can result in an error up to 20 mV.

A chopping technique has been previously used to reduce or completely eliminate the referred offset of the amplifier, however the resistance-capacitance (RC) filtering required to remove a high frequency signal causes only a high impedance output to be available from the amplifier. The high impedance output is undesirable in environments that have a noisy ground reference. Additionally, the output of a chopping circuit may still require an amplifying stage, which could introduce yet another offset.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 illustrates a schematic diagram of an embodiment of a band gap system in accordance with the present invention.

FIG. 2 illustrates a schematic diagram of an embodiment of a band gap circuit that can be used in the band gap system of FIG. 1.

FIG. 3 shows a flow diagram of an embodiment of a method for operating the band gap system of FIG. 1.

FIG. 4 shows a schematic diagram of an embodiment of a switched capacitor amplifier that can be used with the band gap system of FIG. 1.

### DETAILED DESCRIPTION

Embodiments of systems and methods disclosed herein use a switched capacitor gain stage to amplify offset at the input of an amplifier. Comparators in the switched capacitor gain stage then determine whether the amplified offset is positive or negative. A counter decrements or increments respective inputs to a differential pair of an operational transconductance amplifier to achieve a negligible amplifier offset. In this way the reference voltage has low impedance. No additional gain stage is required because the band gap system trims itself and achieves minimum variation without the need to retrieve trim data from a storage device such as flash memory even before the reference voltage is available to operate the storage device.

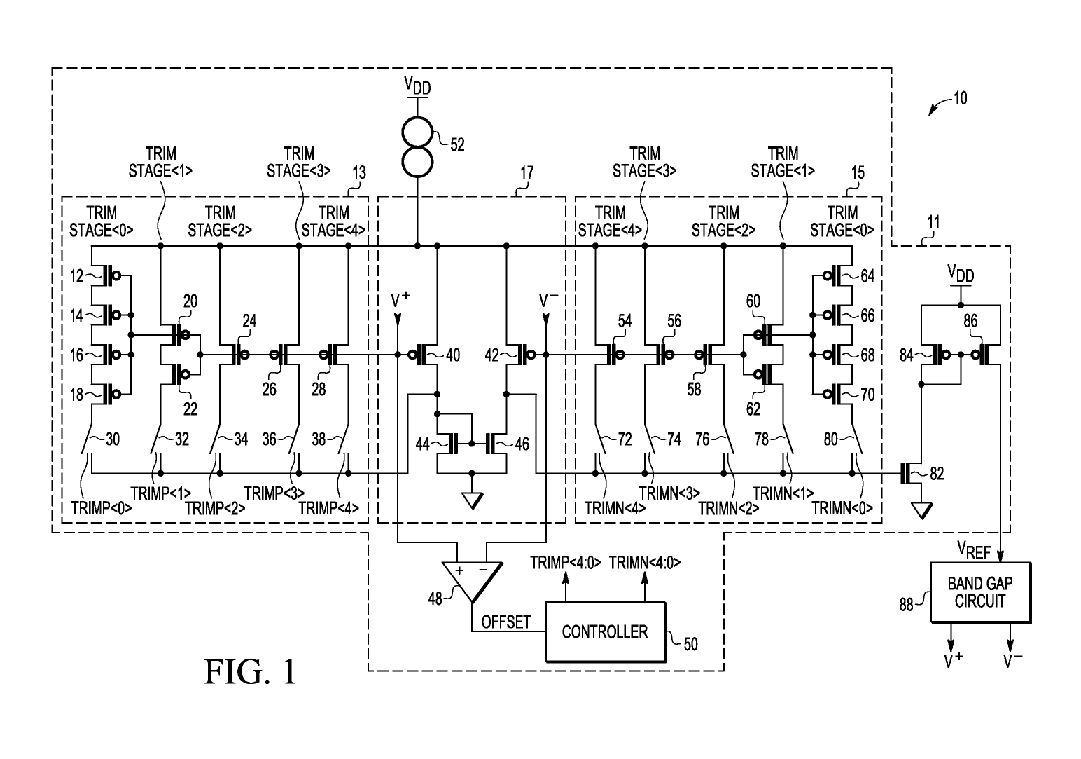

FIG. 1 illustrates a schematic diagram of an embodiment of a band gap system 10 in accordance with the present invention including a trimmable operational transconductance amplifier (OTA) 11 with trim circuits 13, 15 coupled to respective P-channel transistors 40, 42 in OTA 17. Inputs to switched capacitance amplifier (SCA) 48 are coupled to voltage signals (V+ and V−) provided by band gap circuit 88. A supply voltage (VDD) is coupled to current source 52 and current source 52 is source electrodes of transistors 40, 42 in OTA 17. Voltage signals V+ and V− are coupled to control gates of respective transistors 40, 42.

Controller 50 is coupled to the output of SCA 48. Controller 50 provides signals to operate different stages of trim circuits 13, 15 based on the difference in voltage signals (V+ and V−) provided by band gap circuit 88. Trimmable OTA 11 provides a reference voltage (Vref) to band gap circuit 88.

In the example shown, trim circuit 13 includes five stages of transistors coupled in parallel with one another. One or more of the transistor stages can be operated to effectively increase or decrease the threshold voltage of a respective P-channel transistor 40 in OTA 17. A first transistor stage includes four P-channel transistors 12, 14, 16, 18 coupled in series to a switch 30 that is operated according to signal TRIMP(0) output by controller 50.

A second transistor stage includes two P-channel transistors 20, 22 coupled in series to a switch 32 that is operated according to signal TRIMP(1) output by controller 50.

A third transistor stage includes P-channel transistor 24 coupled in series to a switch 34 that is operated according to signal TRIMP(2) output by controller 50.

A fourth transistor stage includes two P-channel transistors 26 coupled in series to a switch 36 that is operated according to signal TRIMP(3) output by controller 50.

A fifth transistor stage includes four P-channel transistor 28 coupled in series to a switch 38 that is operated according to signal TRIMP(4) output by controller 50.

Control gates of the transistors 12-38 are coupled in series to one another and to the control gate of transistor 40.

Trim circuit 15 also includes five stages of transistors coupled in parallel with one another. One or more of the transistor stages can be operated to effectively increase or decrease the threshold voltage of P-channel transistor 42 in OTA 17. A first transistor stage includes four P-channel transistors 64, 66, 68, 70 coupled in series to a switch 80 that is operated according to signal TRIMN(0) output by controller 50.

A second transistor stage includes two P-channel transistors 60, 62 coupled in series to a switch 78 that is operated according to signal TRIMN(1) output by controller 50.

A third transistor stage includes P-channel transistor 58 coupled in series to a switch 76 that is operated according to signal TRIMN(2) output by controller 50.

A fourth transistor stage includes two P-channel transistors 56 coupled in series to a switch 74 that is operated according to signal TRIMN(3) output by controller 50.

A fifth transistor stage includes four P-channel transistor 54 coupled in series to a switch 72 that is operated according to signal TRIMN(4) output by controller 50.

Note that trim circuits 13, 15 may include a different number of trim stages in other embodiments.

Control gates of the transistors 54-70 are coupled in series to one another and to the control gate of transistor 42.

P-channel transistors 40, 42 are coupled in parallel to the trim stages in respective trim circuits 13, 15. The source electrodes of transistors 40, 42 are coupled current source 52. A load circuit is comprised of a drain electrode of a first N-channel transistor 44 coupled to a drain electrode of P-channel transistor 40 and a drain electrode of a second N-channel transistor 46 coupled to a drain electrode of P-channel transistor 42. The source electrodes of N-channel transistors 44, 46 are coupled to one another. The control gates of transistors 44, 46 are also coupled to one another. The control gate of transistor 44 is coupled to the drain electrode of transistor 44.

The drain of transistor 42 is coupled to a control gate of N-channel transistor 82. A source electrode of N-channel transistor 82 is coupled to ground and a drain electrode of N-channel transistor 82 is coupled as input to a current mirror comprised of P-channel transistors 84 and 86. In particular, the drain electrode of N-channel transistor 82 is coupled to the drain electrode of P-channel transistor 84. A source electrode of P-channel transistor 84 is coupled to a source electrode of P-channel transistor 86. Supply voltage VDD is coupled to the source electrodes of transistors 84 and 86. The drain electrode of transistor 84 is coupled to the control gate of transistor 84. The control gates of transistors 84 and 86 are coupled to one another. A drain electrode of transistor 86 is coupled as a reference current input to band gap circuit 88.

N-channel transistor 82 is provided to pass current to band gap circuit 88. P-channel transistor 84 in which the gate and the drain are coupled to each other acts as current-voltage converting means. By applying the converted voltage to the gate terminal of the other P-channel transistor 86 as a component of the current mirror, current according to the size ratio (the gate width ratio) between the transistors 84 and 86 is passed to the P-channel transistor 86 and to band gap circuit 88. In some embodiments, transistors 84 and 86 can have the same size so the current of the transistor 84 is passed to transistor 86.

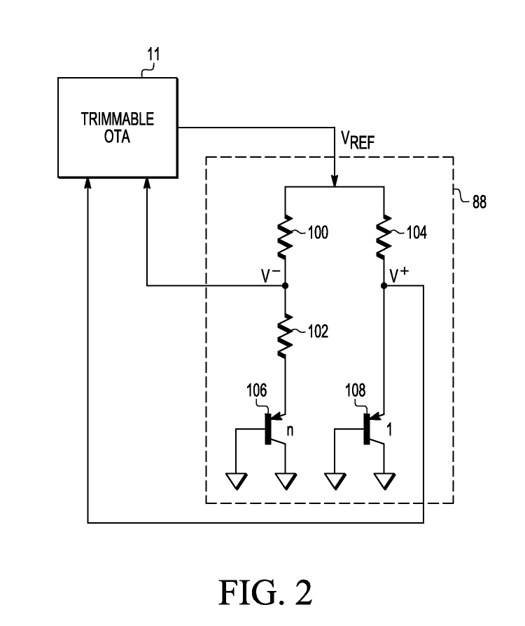

Referring to FIGS. 1 and 2, FIG. 2 illustrates a schematic diagram of an embodiment of a band gap circuit 88 that can be used in the band gap system 10 of FIG. 1 including resistors 100, 102 coupled in series with each other and with bipolar junction transistor 106 between a power supply terminal to which a first power supply voltage Vref is applied and a second power supply voltage Vss such as a ground potential (0V) is applied. Resistor 104 and bipolar transistor 108 are coupled in series with each other and in parallel to resistors 100, 102 and transistor 106 between the first power supply voltage Vref and the second power supply voltage Vss. Resistors 100 and 104 have the same resistance value. The transistors 106 and 108 are set so that the emitters have a ratio of 1:n. In some embodiments, transistor 106 may be replaced with “n” number of diodes connected in parallel of the equivalent size as that of the transistor 106.

The voltage V− is taken at a node between resistor 100 and resistor 102. The voltage V+ is taken at a node between resistor 104 and transistor 108. Voltages V− and V+ are provided as input to trimmable OTA 11. The output of trimmable OTA 11 is provided as voltage Vref to band gap circuit 88.

During operation, it is desirable for the reference voltage to be stable over a specified range of temperatures. In reality, although transistors 40, 42 have identical design specifications, it is difficult to fabricate them to have exactly the same characteristics due to variations in semiconductor fabrication. The difference between transistors 40, 42 causes an offset in which the voltage V− and the voltage V+ have different magnitudes, so that a precise reference voltage cannot be generated. This is particularly true at relatively low voltages where even a slight difference in magnitude between V− and V+ can be amplified by OTA 11 to a relatively large error in Vref. Accordingly, transistors 40 and 42 are trimmed using trim circuits 13, 15 so that the adjusted reference current and voltage output by trimmable OTA 10 is stable.

The aspect ratio of transistors 12-28 and 54-70 in respective trim circuits 13, 15 are selected in relation to the size of P-channel transistors 40, 42 in OTA 17. In one embodiment, the aspect ratios of the fifth through first trim stages are as shown in Table 1 below when transistors 40 and 42 each have an aspect ratio of 72/0.5. Note that Stage 4 corresponds to a fifth trim stage and Stage 0 corresponds to a first trim stage.

TABLE 1
Example Aspect Ratios of Transistors in Trim Stages <4:0>

| Stage | Ratio |
|---|---|
| 4 | (4 × 1)/1 |
| 3 | (2 × 1)/1 |
| 2 | 1/1 |
| 1 | 1/2 |
| 0 | 1/4 |

Other suitable aspect ratios for transistors 12-28, 40, 42, and 54-70 can be used.

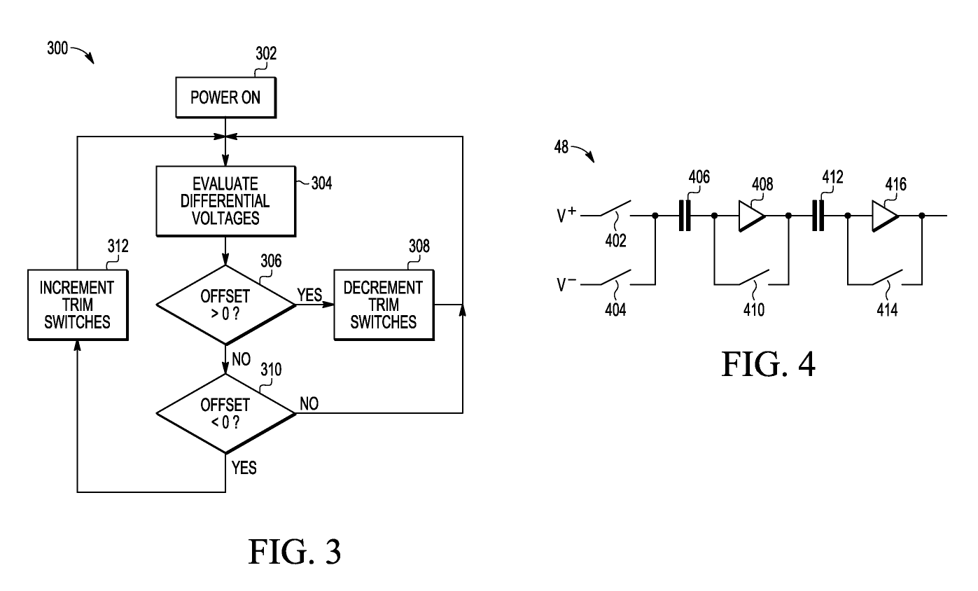

Referring to FIGS. 1 and 3, FIG. 3 shows a flow diagram of an embodiment of a method 300 for operating the band gap system 10 of FIG. 1. Process 302 includes powering on a device in which band gap system 10 is implemented. The device may include integrated circuits comprising low-voltage metal-oxide semiconductor (MOS) or other low-voltage, high precision circuits that require a stable, precise voltage for efficient operation. The power on sequence provides power supply voltage such as VDD to band gap system 10. Another voltage may be provided as VSS, which in one implementation is ground (0 Volts) or a virtual ground voltage level that is lower than VDD.

Process 304 includes evaluating the differential voltage signals V+ and V− input to trimmable OTA 11. The evaluation may be performed by switched capacitor amplifier (SCA) 48, which determines a difference in magnitude (also referred to as “offset”), if any, between voltages V+ and V−. An output voltage from SCA 48 is proportional to the difference between V+ and V−. As shown in FIG. 4, SCA 48 can include a first capacitor 406 connected between switches 404, 404 for V+ and V− and an input of a first amplifier 408. Coupled in parallel with the first amplifier 408 is another switch 410. A second capacitor 412 is connected between an output of the first amplifier 408 and an input of a second amplifier 416. Coupled in parallel with the second amplifier 416 is a switch 414. An output of the second amplifier 416 connected to an output terminal.

In operation, SCA 48 has a sample/hold mode and a compare mode. During the sample/hold mode, the switches 402, 404, 410, 414 are closed. Each of the amplifiers 408, 416 is biased to a switchpoint voltage and a charge is established on the capacitors 406, 412. The charge on the first capacitor 406 is equal to the product of the capacitance of the first capacitor 406 and the difference in voltage potential between V+ and the switchpoint of the first amplifier 408. The charge on the second capacitor 412 is equal to the product of the capacitance of the second capacitor 412 and the difference in voltage potential between the switchpoint of the first amplifier 408 and the switchpoint of the second amplifier 416. When the switches 410, 414 in parallel with the amplifiers 408, 416 are electrically opened, SCA 48 is in a high gain, open loop mode having a switchpoint equal to V+. The switch 402 on V+ is then electrically opened and the switch 404 on V− is electrically closed resulting in the output offset voltage being at a high logic level if V− is less than V+ and at a low logic level if V− is greater than V+.

The offset voltage output by SCA 48 is provided to controller 50, in which processes 306-312 can be implemented. For the purposes of processes 306 and 310, a high logic level of the offset voltage is considered as a value greater than zero (>0). A low logic level of the offset voltage is considered as a value less than zero (<0).

As an initial setting, trim circuits 13 and 15 may be initialized with the switches to couple middle trim stages, such as trim stages <2> or trim stages <3>, to a respective transistor 40, 42. For example, if trim stages <2> are initially coupled to respective transistors 40, 42, switches 34 and 76 will be closed and remaining trim stage switches 30, 32, 36, 38, 72, 74, 78, 80 will be open.

Process 306 determines whether the offset voltage is greater than zero (0). If the offset is greater than zero, process 306 transitions to process 308 to decrement the trim switches. The decrement can be performed by moving from a first trim stage to the next lower trim stage in trim circuit 13, for example, from trim stage <3> to trim stage <2> by opening switch 36 and closing switch 34. An equivalent way to decrement the trim switches is by moving from a first trim stage to the next higher trim stage in trim circuit 15, for example, from trim stage <2> to trim stage <3> by opening switch 74 and closing switch 76. Process 308 then transitions back to process 304 to periodically evaluate and correct offset between transistors 40, 42.

If the offset voltage was not greater than zero, process 310 determines whether the offset voltage is less than zero (0). If the offset is less than zero, process 310 transitions to process 312 to increment the trim switches. The increment can be performed by moving from a first trim stage to the next higher trim stage in trim circuit 13, for example, from trim stage <3> to trim stage <4> by opening switch 36 and closing switch 38. An equivalent way to increment the trim switches is by moving from a first trim stage to the next lower trim stage in trim circuit 15, for example, from trim stage <2> to trim stage <1> by opening switch 76 and closing switch 78. Process 312 then transitions back to process 304 to periodically evaluate and correct offset between transistors 40, 42.

If the offset voltage is zero, process 310 transitions back to process 304 to periodically evaluate and correct offset between transistors 40, 42.

By now it should be appreciated that in some embodiments of systems and methods disclosed herein provide a band gap system 10 that is capable of adjusting the effective values of transistors 40, 42 to remove amplifier offset error that may affect band gap reference voltages. The adjustment is made by determining whether an offset exists, and if so, incrementing or decrementing trim stages coupled to one or both of transistors 40, 42. The trim stages can be adjusted until the offset is removed. If another offset is subsequently detected, the trim stages can again be adjusted to remove the offset.

In some embodiments, a bandgap reference system 10 can comprise a bandgap circuit 88 comprising a pair of diode devices 106, 108, the bandgap circuit providing a differential output V+, V− comprising a first output V+ and a second output V− and having a reference terminal Vref at which is provided a bandgap reference voltage. An operational transconductance amplifier 40, 42, 44, 46 can have a first input coupled to the first output of the bandgap circuit, a second input coupled to the second output of the bandgap reference circuit, and an output coupled to the reference terminal. An offset controller 13, 15, 48, 50 can be coupled to the operational transconductance amplifier and to the first and second outputs of the bandgap circuit that trims the operational transconductance amplifier as needed to ensure an offset of the operational transconductance amplifier is below a predetermined level.

In another aspect, the offset controller can comprise a trim circuit 13, 15 comprising a plurality of transistors 20-28, 54-62 capable of being selectively coupled to the operational transconductance amplifier to trim the operational transconductance amplifier.

In another aspect, the offset controller can further comprise a switched capacitor offset detector 48 coupled to the first and second outputs of the bandgap circuit and an output, and a trim controller 50 having an input coupled to the output of the switched capacitor offset detector that selects which of the plurality of transistors are coupled to the operational transconductance amplifier to ensure the offset is below the predetermined level.

In another aspect, the operational transconductance amplifier can comprise a differential pair of transistors comprising a first transistor 40 coupled to the first output of the bandgap circuit and a second transistor 42 coupled to the second output of the bandgap circuit. The trim circuit can comprise a first portion 13 of the plurality of transistors capable of being coupled in parallel with the first transistor and a second portion 15 of the plurality of transistors capable of being coupled in parallel with the second transistor.

In another aspect, the first portion of the plurality of transistors and the second portion of the plurality of transistors can be binary weighted.

In another aspect, the pair of diode devices can comprise a pair of diode-connected PNP bipolar transistors.

In another aspect, the pair of diode devices can comprise a pair of PN junctions.

In another aspect, the bandgap reference system can have an output stage 82, 84, 86 comprising a current mirror coupled to the reference terminal.

In another aspect, the offset controller can comprise a first plurality of transistors 13 capable of being coupled to the operational transconductance amplifier and a second plurality of transistors 15 capable of being coupled to the operational transconductance amplifier.

In another aspect, the offset controller can initially couple a first portion of the first plurality of transistors to the operational transconductance amplifier and decouple a second portion of the first plurality of transistors from the operational transconductance amplifier and selectively decouples transistors from the first portion or couples selected transistors of the second portion to the operational transconductance amplifier in ensuring that the offset is below the predetermined level.

In other embodiments, a bandgap reference system 10 can comprise a bandgap circuit 88 comprising a pair of diode devices 106, 108, the bandgap circuit providing a differential output V+, V− comprising a first output V+ and a second output V− and having a reference terminal Vref at which is provided a bandgap reference voltage. A trimmable operational transconductance amplifier 11 can have a first input coupled to the first output V+ of the bandgap circuit, a second input coupled to the second output V− of the bandgap reference circuit, and an output coupled to the reference terminal. The trimmable operational transconductance amplifier 11 can comprise a differential pair of transistors 40, 42 comprising a first transistor 40 coupled to the first output of the bandgap circuit and a second transistor 42 coupled to the second output of the band gap circuit, a first trim 13 circuit having transistors capable of being selectively coupled in parallel with the first transistor, a second trim circuit 15 having transistors capable of being selectively coupled in parallel with the second transistor, and an offset control circuit 48, 50 coupled to the first and second outputs of the bandgap circuit and the first and second outputs of reference circuit that uses the first and second trim circuits to minimize an offset of the trimmable operational transconductance amplifier.

In another aspect, the trimmable operational transconductance amplifier can have an output stage 82, 84, 86 comprising a current mirror.

In another aspect, the first trim circuit can have a first portion and a second portion. The first portion is initially coupled in parallel with the first transistor. The second portion is initially decoupled from being in parallel with the first transistor. Transistors of the first portion can be selectively decoupled from being in parallel with the first transistor when the offset is in a first direction. Transistors of the second portion can be selectively coupled in parallel with the second transistor when the offset is in a second direction.

In another aspect, transistors of the first trim circuit 13 can be initially decoupled from being in parallel with the first transistor. Transistors of the second trim circuit 15 can be initially decoupled from being in parallel with the second transistor. Transistors of the first trim circuit can be selectively coupled in parallel with the first transistor when the offset is in a first direction. Transistors of the second trim circuit can be selectively coupled in parallel with the second transistor when the offset is in a second direction.

In another aspect, the transistors of the first trim circuit can be binary weighted.

In another aspect, the offset control circuit can comprise a switched capacitor offset detector 48 coupled to the first and second outputs of the bandgap circuit and having an output. A trim controller 50 can have an input coupled to the output of the switched capacitor offset detector that selectively couples transistors of the first trim circuit in parallel with the first transistor and selectively couples transistors of the second trim circuit in parallel with the second transistor in order to minimize the offset of the trimmable operational transconductance amplifier.

In another aspect, the diode devices comprise PNP transistors can each have a base and collector coupled to a ground terminal.

In still other embodiments, a method of operating a bandgap reference system 10 to provide a bandgap reference voltage Vref can comprise providing a pair of differential signals V+, V− from a bandgap circuit 88 to a differential amplifier 40, 42, 44, 46 that has an output at a bandgap terminal of the bandgap circuit. The bandgap circuit can have a pair of diode devices 106, 108. The bandgap terminal can be for having the bandgap reference voltage. The differential amplifier can have an offset. Minimizing the offset by trimming the differential amplifier can be by incrementing trim switches 13 when the offset is in a first direction and decrementing trim switches 15 when the offset is in a second direction.

In another aspect, the providing a pair of differential signals can be further characterized by the differential amplifier comprising a first transistor (40) and a second transistor (42) of a pair of differential transistors. The minimizing the offset further characterized by the trim switches can comprise a first set of transistors (13) capable of being coupled in parallel with the first transistor and a second set of transistors (15) capable of being coupled in parallel with the second transistor. Trim switches can be incremented by increasing a number of transistors of the first set coupled in parallel with the first transistor. Trim switches can be decremented by increasing a number of transistors coupled in parallel with the second transistor.

In another aspect, trim switches can be incremented by decreasing a number of transistors of the second set coupled in parallel with the second transistor. Trim switches can be decremented by decreasing a number of transistors of the first set coupled in parallel with the first transistor.

Because the apparatus implementing the present disclosure is, for the most part, composed of electronic components and circuits known to those skilled in the art, circuit details will not be explained in any greater extent than that considered necessary as illustrated above, for the understanding and appreciation of the underlying concepts of the present disclosure and in order not to obfuscate or distract from the teachings of the present disclosure.

Some of the above embodiments, as applicable, may be implemented using a variety of different information processing systems. For example, although FIG. 1 and the discussion thereof describe an exemplary information processing architecture, this exemplary architecture is presented merely to provide a useful reference in discussing various aspects of the disclosure. Of course, the description of the architecture has been simplified for purposes of discussion, and it is just one of many different types of appropriate architectures that may be used in accordance with the disclosure. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

What is claimed is:

1. A bandgap reference system, comprising:
a bandgap circuit comprising a pair of diode devices, the bandgap circuit providing a differential output comprising a first output and a second output and having a reference terminal at which is provided a bandgap reference voltage;
an operational transconductance amplifier having a first input coupled to the first output of the bandgap circuit, a second input coupled to the second output of the bandgap reference circuit, and an output coupled to the reference terminal; and
an offset controller coupled to the operational transconductance amplifier and to the first and second outputs of the bandgap circuit that trims the operational transconductance amplifier as needed to ensure an offset of the operational transconductance amplifier is below a predetermined level.

2. The bandgap reference system of claim 1, wherein the offset controller comprises:
a trim circuit comprising a plurality of transistors capable of being selectively coupled to the operational transconductance amplifier to trim the operational transconductance amplifier.

3. The bandgap reference system of claim 2, wherein the offset controller further comprises:
a switched capacitor offset detector coupled to the first and second outputs of the bandgap circuit and an output; and
a trim controller having an input coupled to the output of the switched capacitor offset detector that selects which of the plurality of transistors are coupled to the operational transconductance amplifier to ensure the offset is below the predetermined level.

4. The bandgap reference system of claim 3, wherein:
the operational transconductance amplifier comprises a differential pair of transistors comprising a first transistor coupled to the first output of the bandgap circuit and a second transistor coupled to the second output of the bandgap circuit; and
the trim circuit comprises a first portion of the plurality of transistors capable of being coupled in parallel with the first transistor and a second portion of the plurality of transistors capable of being coupled in parallel with the second transistor.

5. The bandgap reference system of the claim 4, wherein the first portion of the plurality of transistors and the second portion of the plurality of transistors are binary weighted.

6. The bandgap reference system of claim 1, wherein the pair of diode devices comprise a pair of diode-connected PNP bipolar transistors.

7. The bandgap reference system of claim 1, wherein the pair of diode devices comprise a pair of PN junctions.

8. The bandgap reference system of claim 1, wherein the bandgap reference system has an output stage comprising a current mirror coupled to the reference terminal.

9. The bandgap reference system of claim 1, wherein:
the offset controller comprises a first plurality of transistors capable of being coupled to the operational transconductance amplifier and a second plurality of transistors capable of being coupled to the operational transconductance amplifier.

10. The bandgap reference system of claim 9, wherein:
the offset controller initially couples a first portion of the first plurality of transistors to the operational transconductance amplifier and decouples a second portion of the first plurality of transistors from the operational transconductance amplifier and selectively decouples transistors from the first portion or couples selected transistors of the second portion to the operational transconductance amplifier in ensuring that the offset is below the predetermined level.

11. A bandgap reference system, comprising:
a bandgap circuit comprising a pair of diode devices, the bandgap circuit providing a differential output comprising a first output and a second output and having a reference terminal at which is provided a bandgap reference voltage;
a trimmable operational transconductance amplifier having a first input coupled to the first output of the bandgap circuit, a second input coupled to the second output of the bandgap reference circuit, and an output coupled to the reference terminal, comprising a differential pair of transistors comprising a first transistor coupled to the first output of the bandgap circuit and a second transistor coupled to the second output of the band gap circuit, a first trim circuit having transistors capable of being selectively coupled in parallel with the first transistor, a second trim circuit having transistors capable of being selectively coupled in parallel with the second transistor, and an offset control circuit coupled to the first and second outputs of the bandgap circuit and the first and second outputs of reference circuit that uses the first and second trim circuits to minimize an offset of the trimmable operational transconductance amplifier.

12. The bandgap reference system of claim 11, wherein the trimmable operational transconductance amplifier has an output stage comprising a current mirror.

13. The bandgap reference system of claim 11, wherein:
the first trim circuit has a first portion and a second portion;
the first portion is initially coupled in parallel with the first transistor;
the second portion is initially decoupled from being in parallel with the first transistor;
transistors of the first portion are selectively decoupled from being in parallel with the first transistor when the offset is in a first direction; and
transistors of the second portion are selectively coupled in parallel with the second transistor when the offset is in a second direction.

14. The bandgap reference system of claim 11, wherein:
transistors of the first trim circuit are initially decoupled from being in parallel with the first transistor;
transistors of the second trim circuit are initially decoupled from being in parallel with the second transistor;
transistors of the first trim circuit are selectively coupled in parallel with the first transistor when the offset is in a first direction; and
transistors of the second trim circuit are selectively coupled in parallel with the second transistor when the offset is in a second direction.

15. The bandgap reference system of claim 14, wherein the transistors of the first trim circuit are binary weighted.

16. The bandgap reference system of claim 11, wherein the offset control circuit comprises:
a switched capacitor offset detector coupled to the first and second outputs of the bandgap circuit and having an output; and
a trim controller having an input coupled to the output of the switched capacitor offset detector that selectively couples transistors of the first trim circuit in parallel with the first transistor and selectively couples transistors of the second trim circuit in parallel with the second transistor in order to minimize the offset of the trimmable operational transconductance amplifier.

17. The bandgap reference of claim 11, wherein the diode devices comprise PNP transistors having each having a base and collector coupled to a ground terminal.

18. A method of operating a bandgap reference system to provide a bandgap reference voltage, comprising:
providing a pair of differential signals from a bandgap circuit to a differential amplifier that has an output at a bandgap terminal of the bandgap circuit, wherein:
the bandgap circuit has a pair of diode devices;
the bandgap terminal is for having the bandgap reference voltage; and
the differential amplifier has an offset; and
minimizing the offset by trimming the differential amplifier by incrementing trim switches when the offset is in a first direction and decrementing trim switches when the offset is in a second direction.

19. The method of claim 18, wherein
the providing a pair of differential signals is further characterized by the differential amplifier comprising a first transistor and a second transistor of a pair of differential transistors;
the minimizing the offset further characterized by the trim switches comprising a first set of transistors capable of being coupled in parallel with the first transistor and a second set of transistors capable of being coupled in parallel with the second transistor;
incrementing trim switches occurs by increasing a number of transistors of the first set coupled in parallel with the first transistor; and
decrementing trim switches occurs by increasing a number of transistors coupled in parallel with the second transistor.

20. The method of claim 19, wherein:
incrementing trim switches occurs by decreasing a number of transistors of the second set coupled in parallel with the second transistor; and
decrementing trim switches occurs by decreasing a number of transistors of the first set coupled in parallel with the first transistor.
